(19) United States
(12) Patent Application Publication
(10) Pub. No.: US 2024/0300031 A1
(43) Pub. Date: Sep. 12, 2024

(54) GAUGE PLATE FOR DRILLING ACCOMMODATION HOLE

(71) Applicant: Chia-Chang Chiang, Taichung City (TW)

(72) Inventor: Chia-Chang Chiang, Taichung City (TW)

(21) Appl. No.: 18/118,757

(22) Filed: Mar. 8, 2023

(51) Int. Cl. B23B 47/28; B23B 51/10

(52) U.S. Cl. CPC B23B 47/287; B23B 51/10

(57) ABSTRACT

A gauge plate is configured to drill at least one accommodation hole in at least one size by using a square reamer. The gauge plate contains: at least one alignment orifice defined thereof and corresponding to the at least one size so as to accommodate the square reamer in the at least one accommodation hole. The gauge plate contains four L-shaped slots formed on four corners thereof, corresponding to the at least one alignment orifice, and configured to define the at least one size of the at least one accommodation hole. The gauge plate further contains multiple V-shaped notches defined on the four peripheral sides thereof and corresponding to the four alignment orifices and the four T-shaped slots, and a size value portion is configured to display three size values.

### TECHNICAL FIELD

The present disclosure relates to a gauge plate which is configured to drill at least one accommodation hole to accommodate a square drill tool (such as a square reamer).

### BACKGROUND

An operation panel of a conventional distribution box contains at least one square meter fixed thereon, wherein at least one square accommodation hole is drilled on the operational panel. Referring to FIG. 13, before drilling the at least one square accommodation hole, a central orifice is marked at a predetermined position of a workpiece, and a size (such as 91 mm×91 mm) of each of the at least one accommodation hole is drawn. In addition, a worker has to plan a central point 71 of a drilled position of each accommodation hole, and the size a, b of each accommodation hole is planned by using a ruler, thereafter the size of each accommodation hole is cut.

However, such a drilling process is troublesome and time-consuming and will spend a high mold cost.

The present invention has arisen to mitigate and/or obviate the afore-described disadvantages.

### SUMMARY

A primary aspect of the present invention is to provide a gauge plate which is capable of overcoming the shortcomings of the conventional gauge plate for drilling at least one accommodation hole.

To obtain above-mentioned aspects, a gauge plate provided by the present invention is configured to drill at least one accommodation hole in at least one size by using a square reamer. The gauge plate contains: at least one alignment orifice defined on the gauge plate and corresponding to the at least one size so as to accommodate the square reamer in the at least one accommodation hole, four L-shaped slots formed on four corners of the gauge plate, corresponding to the at least one alignment orifice, and configured to define the at least one size of the at least one accommodation hole. The gauge plate further contains multiple V-shaped notches defined on the four peripheral sides of the gauge plate and corresponding to the four alignment orifices and the four T-shaped slots so that the gauge plate is aligned with the four alignment orifices and the four T-shaped slots by using the multiple V-shaped notches, and a size value portion is configured to display three size values.

In operation, the four L-shaped slots of the gauge plate are aligned with a criss-cross dotted line of a central point of spaced from a first distance and a second distance of the workpiece, and a peripheral side of the at least one accommodation hole is cut by using the four L-shaped slots, thus drilling the at least one accommodation hole easily and quickly.

Preferably, the gauge plate comprises a ruler scale formed on a first peripheral side of the four peripheral sides of the gauge plate and configured to measure a size and to draw a line.

Preferably, the gauge plate contains two L-shaped ribs extending from two corners of the four corners of the gauge plate away from the level and configured to raise up the gauge plate.

Preferably, the gauge plate further contains a level arranged on a center of the second peripheral side thereof and configured to make a level correction.

Preferably, the gauge plate contains multiple magnetic attraction elements extending adjacent to the four corners of the gauge plate, made of metal and configured to magnetically attach the gauge plate on a metal element.

Preferably, the gauge plate is made of magnetic metal material so as to magnetically attach on the metal element.

Other objects and features will be in part apparent and in part pointed out hereinafter.

### BRIEF DESCRIPTION OF THE DRAWINGS

FIG. 1 is a perspective view showing the assembly of a gauge plate according to the present invention.

FIG. 2 is a side plan view showing the operation of the gauge plate according to the present invention.

FIG. 3 is another side plan view showing the operation of the gauge plate according to the present invention.

FIG. 4 is also another side plan view showing the operation of the gauge plate according to the present invention.

FIG. 5 is still another side plan view showing the operation of the gauge plate according to the present invention.

FIG. 6 is a perspective view showing the application of the gauge plate according to the present invention.

FIG. 7 is another perspective view showing the application of the gauge plate according to the present invention.

FIG. 8 is also another perspective view showing the application of the gauge plate according to the present invention.

FIG. 9 is still another perspective view showing the application of the gauge plate according to the present invention.

FIG. 10 is a perspective view showing the application of the gauge plate according to the present invention.

FIG. 11 is another perspective view showing the application of the gauge plate according to the present invention.

FIG. 12 is also another perspective view showing the application of the gauge plate according to the present invention.

FIG. 13 is a side plan view showing the application of a conventional gauge plate.

### DETAILED DESCRIPTION

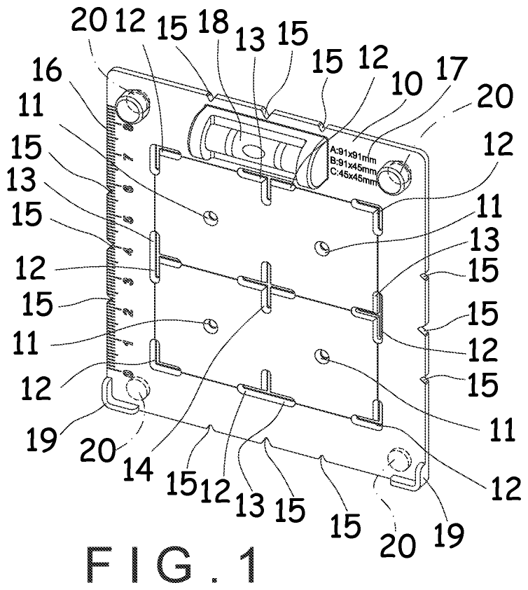

FIG. 1 is a perspective view showing the assembly of a gauge plate according to the present invention. The gauge plate 10 is configured to drill at least one accommodation hole in at least one size by using a square reamer, and the gauge plate 10 comprises: four alignment orifices 11, four L-shaped slots 12 formed on four corners of the gauge plate 10 and corresponding to the four alignment orifices 11, four T-shaped slots 13 defined adjacent to four peripheral sides of the gauge plate 10 and a respective one of the four T-shaped slots 13 is staked by any two of another eight L-shaped slots 12, and the gauge plate 10 further comprises a criss-cross slot 14 formed on a center thereof, such that a size of a respective one accommodation hole is defined by the four L-shaped slots 12, wherein a size of a first accommodation hole is 91 mm×91 mm and the first accommodation hole 91 is formed in a large square shape, a size of a second accommodation hole size is 45 mm×45 mm and the second accommodation hole is formed in a small square shape, and a size of a third hole accommodation hole is 45 mm×91 mm and the third accommodation hole is formed in a rectangle shape. The respective one T-shaped slot 13 of the four T-shaped slots 13 is defined between any two adjacent L-shaped slots 12 of the four L-shaped slots 12, and the other two T-shaped slots 13 are staked in a cross shape among the four L-shaped slots 12, wherein the gauge plate 10 further comprises multiple V-shaped notches 15 defined on the four peripheral sides of the gauge plate 10 and corresponding to the four alignment orifices 11 and the four T-shaped slots 13 so that the gauge plate 10 is aligned with the four alignment orifices 11 and the four T-shaped slots 13 by using the multiple V-shaped notches 15, wherein the gauge plate 10 further comprises: a ruler scale 16 formed on a first peripheral side of the four peripheral sides of the gauge plate 10 and configured to measure a size and to draw a line, a size value portion 17 formed on a second peripheral side of the four peripheral sides of the gauge plate 10 which is connected with the first peripheral side of the gauge plate 10, and the size value portion 17 is configured to display three size values, and the gauge plate 10 further comprises a level 18 arranged on a center of the second peripheral side thereof and configured to make a level correction, two L-shaped ribs 19 extending from two corners of the four corners of the gauge plate 10 away from the level 18 and configured to raise up the gauge plate 10, and multiple magnetic attraction elements 20 extending adjacent to the four corners of the gauge plate 10, made of metal and configured to magnetically attach the gauge plate 10 on a metal element, such as a metal plate. Preferably, the gauge plate 10 is made of magnetic metal material so as to magnetically attach on the metal element. Alternatively, the gauge plate is made of plastic material. Alternatively, the gauge plate 10 is made of plastic material.

In another embodiment, the gauge plate 10 comprises a sole accommodation hole, a size of which is 45 mm×45 mm.

In this embodiment, the gauge plate 10 comprises three accommodation holes which are the first accommodation hole, the second accommodation hole, and the third accommodation hole, wherein a size of the first accommodation hole is 91 mm×91 mm, a size of the second accommodation hole is 45 mm×45 mm, and a size of the third accommodation hole is 45 mm×91 mm. Furthermore, the gauge plate 10 comprises further comprises a fourth accommodation hole defined on a surface thereof back to the three accommodation holes of the gauge plate 10, and a size of the fourth accommodation hole is 68 mm×68 mm.

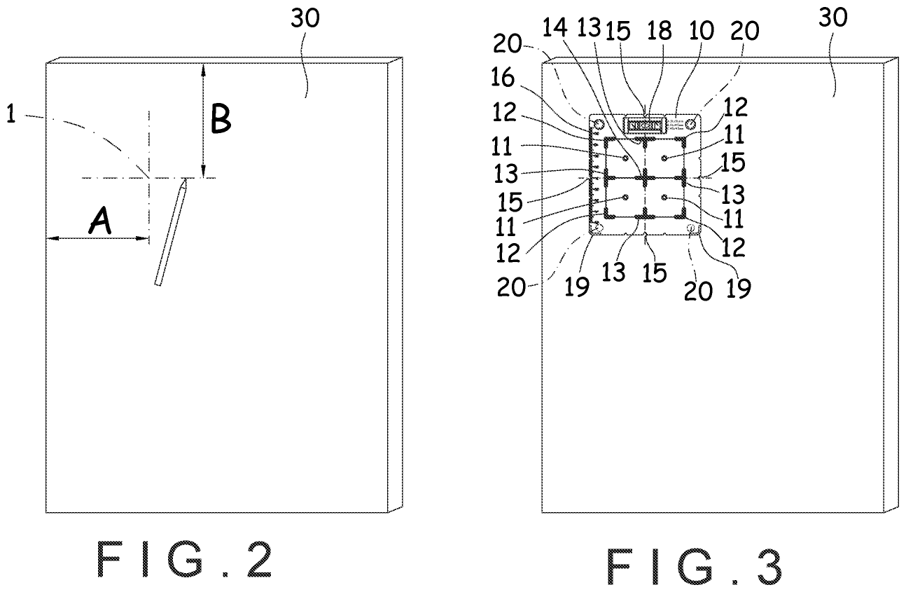

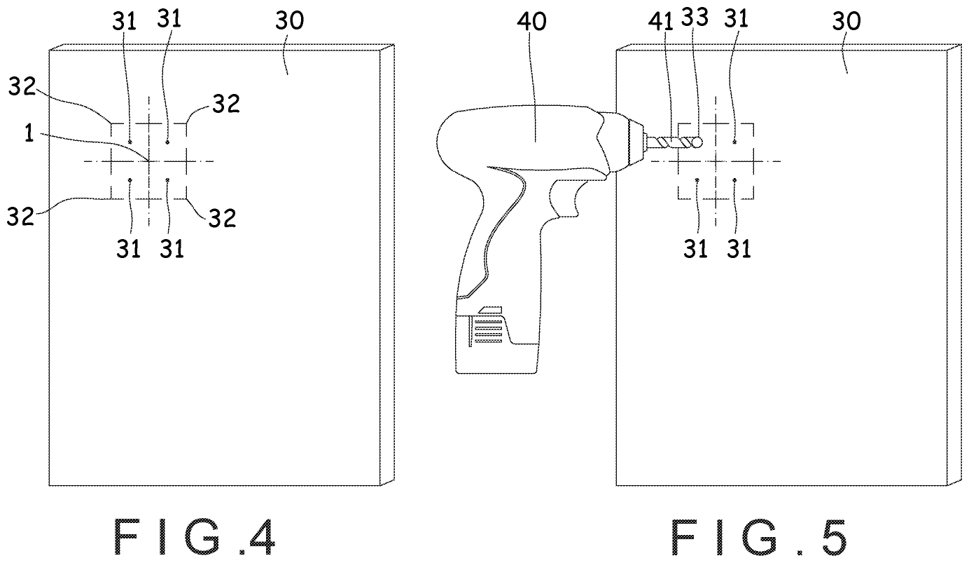

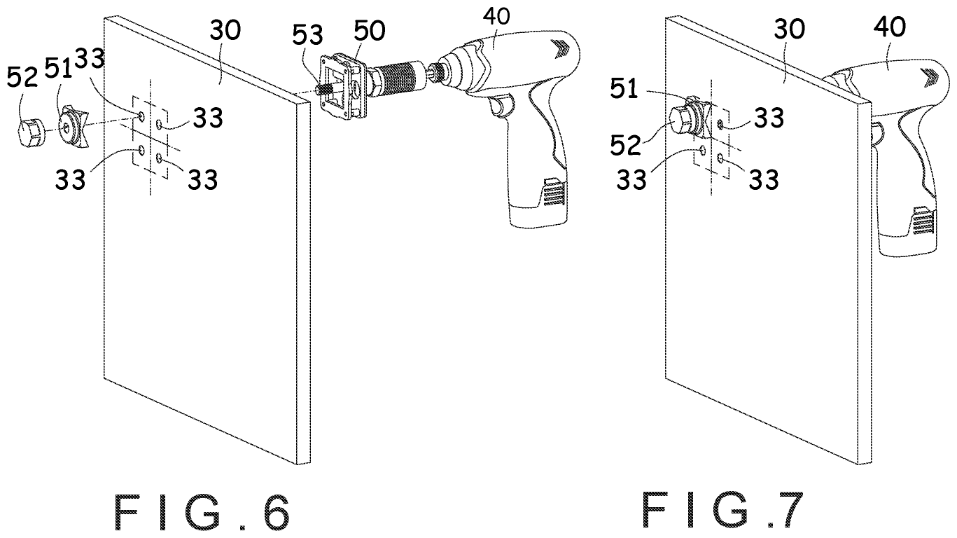

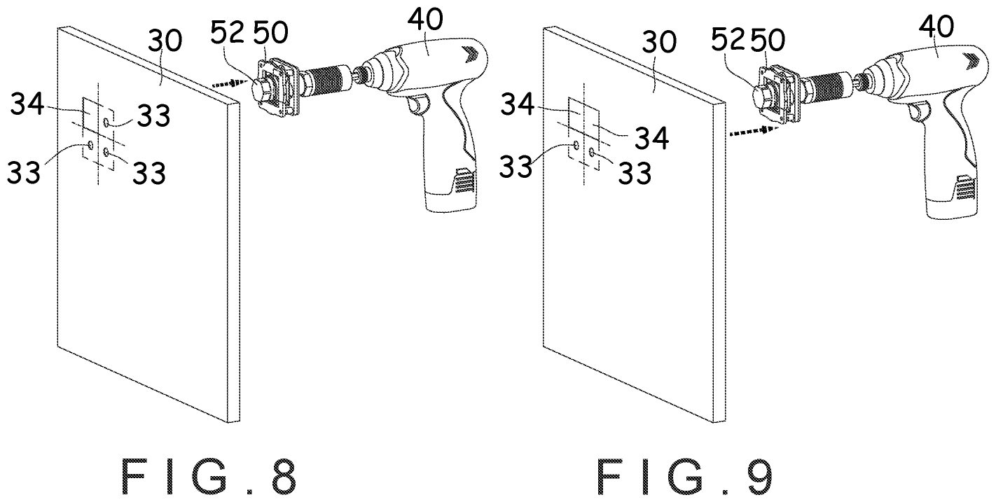

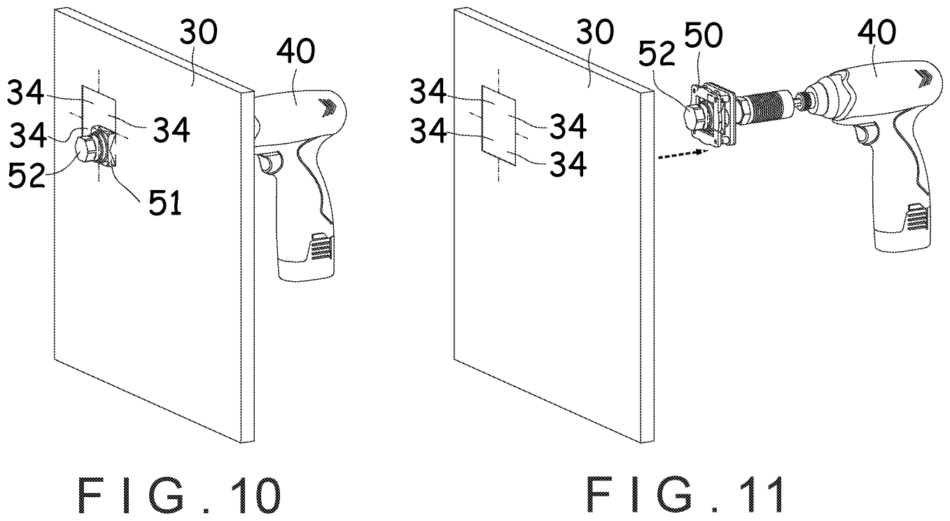

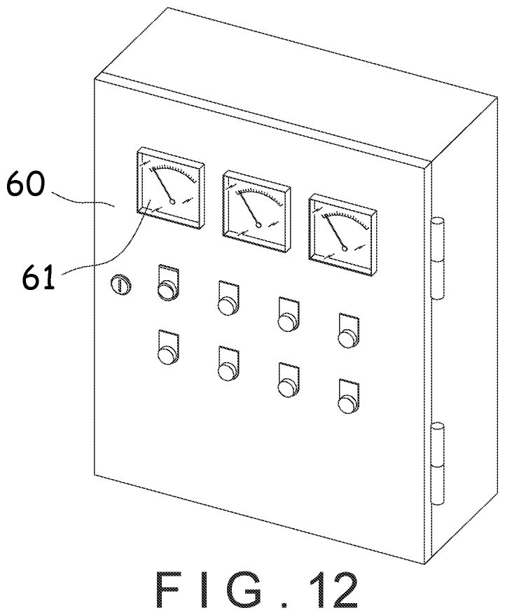

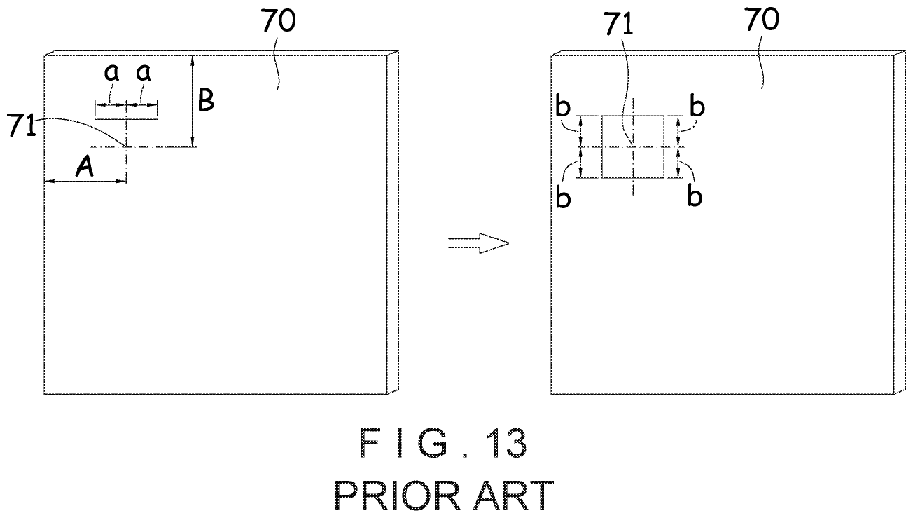

A method of operating the gauge plate of the present invention (for example, drilling an accommodation hole in 91 mm×91 mm at a predetermined position of a workpiece 30) comprises steps of:
1) drawing a criss-cross dotted line from a first central point 1 which is spaced from a first distance A and a second distance B of the workpiece 30, as shown in FIG. 2;
2) selecting the gauge plate 10 in a desired size, wherein some of the multiple V-shaped notches 15 of the gauge plate 10 are aligned with the criss-cross dotted line of the first central point 1, as shown in FIG. 3;
3) drawing four second central points 31 and four right-angle dotted lines 32 on the workpiece 30 by using the four alignment orifices 11 and the four L-shaped slots 12 of the gauge plate 10, as illustrated in FIG. 4;
4) drilling four through holes 33 on the four second central points 31 by way of a drill bit 41 of an electrical tool 40 to accommodate the square reamer, as shown in FIG. 5;
5) providing the square reamer, wherein the square reamer includes a female mold 50, a male mold 51, a screw nut 52, and a pull rod 53, wherein the pull rod 53 is inserted through the four through holes 33, the female mold 50 and the male mold 51 are configured to clamp the workpiece 30, and the screw nut 52 is configured to screw with the pull rod 53 and the male mold 51, as illustrated in FIGS. 6 and 7;
6) driving the male mold 51 to drill a first drilled accommodation hole 34 by using the pull rod 53 of the square reamer, as shown in FIGS. 8; and
7) repeating the steps 5) and 6) to drill second, third and fourth drilled accommodation holes 34, as illustrated in FIGS. 9 to 11; and
8) applying the steps 1) to 7) to fix three square meters 61 on an operational panel 60, as shown in FIG. 12.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A gauge plate being configured to drill at least one accommodation hole in at least one size by using a square reamer, and the gauge plate comprising: at least one alignment orifice defined on the gauge plate and corresponding to the at least one size so as to accommodate the square reamer in the at least one accommodation hole, four L-shaped slots formed on four corners of the gauge plate, corresponding to the at least one alignment orifice, and configured to define the at least one size of the at least one accommodation hole, wherein the gauge plate further comprises multiple V-shaped notches defined on the four peripheral sides of the gauge plate and corresponding to the four alignment orifices and the four T-shaped slots so that the gauge plate is aligned with the four alignment orifices and the four T-shaped slots by using the multiple V-shaped notches, and a size value portion is configured to display three size values.

2. The gauge plate as claimed in claim 1, wherein the gauge plate is configured to drill multiple accommodation holes in multiple sizes, four T-shaped slots defined adjacent to four peripheral sides of the gauge plate and a respective one of the four T-shaped slots is staked by any two of another eight L-shaped slots, and the gauge plate further comprises a criss-cross slot formed on a center thereof, wherein the gauge plate further comprises multiple V-shaped notches defined on the four peripheral sides of the gauge plate and corresponding to the criss-cross slot so that the gauge plate is aligned with the criss-cross slot by using the multiple V-shaped notches.

3. The gauge plate as claimed in claim 1, wherein the gauge plate further comprises a level arranged on a center of the second peripheral side thereof.

4. The gauge plate as claimed in claim 1, wherein the gauge plate is made of magnetic attraction material.

5. The gauge plate as claimed in claim 1, wherein the gauge plate is made of plastic material, and the gauge plate further comprises multiple magnetic attraction elements extending adjacent to the four corners of the gauge plate and made of metal.

6. The gauge plate as claimed in claim 1, wherein the gauge plate further comprises a ruler scale formed on a first peripheral side of the four peripheral sides thereof.

7. The gauge plate as claimed in claim 1, wherein the gauge plate further comprises two L-shaped ribs extending from two corners of the four corners of the gauge plate away from the level.
